(19) United States
(12) Patent Application Publication
(10) Pub. No.: US 2016/0055513 A1
(43) Pub. Date: Feb. 25, 2016

(54) ACTIVATING OFFERS WITH A DIGITAL WALLET APPLICATION

(71) Applicant: GOOGLE INC., Mountain View, CA (US)

(72) Inventors: Stephen Kuhn, Tarrytown, NY (US); Anthony J. Sabetti, Murphy, TX (US)

(21) Appl. No.: 14/835,701

(22) Filed: Aug. 25, 2015

Related U.S. Application Data
(60) Provisional application No. 62/041,322, filed on Aug. 25, 2014.

(51) Int. Cl. G06Q 30/02; G06Q 20/36

(52) U.S. Cl. CPC G06Q 30/0222; G06Q 30/0238; G06Q 20/363

(57) ABSTRACT

Providing offers to a point of sale (“POS”) terminal comprises a digital wallet of a user and a digital wallet system. A user approaching a POS terminal to conduct a transaction opens a digital wallet application on the user computing device and accesses an offer page of an offer on the digital wallet application. When the offer page is accessed, the offer parameters are loaded onto a secure element, or armed in the memory of the user computing device, and readied for communication to the POS terminal. When the user taps the user computing device to the POS terminal the offer is communicated. If the user navigates away from the offer page, the offer parameters are removed from the secure element and are no longer readied for communication.

### RELATED APPLICATIONS

This application claims priority to U.S. Provisional Patent Application No. 62/041,322, filed Aug. 25, 2014 and entitled “Systems, Methods, and Computer Program Products for Contactless Transactions,” the entire contents of which are hereby fully incorporated herein by reference.

### TECHNICAL FIELD

The present disclosure relates to activating an offer on a digital wallet application on a user computing device when a user accesses a detail page of the offer. Activating an offer while the offer is being viewed allows a user to confirm the use of the offer at the time of communication to a point of sale terminal at a merchant system.

### BACKGROUND

Mobile device payments can be conducted by a user computing device with a point of sale (“POS”) terminal of a merchant system. A user computing device can communicate with the POS terminal via near field communication (“NFC”), BLUETOOTH, barcode, Wi-Fi, infrared, or any other suitable communication technology. The payment can be initiated by a “tap,” swipe, or other motion of the user computing device or via a feature selection from the user. The user computing device can host a payment application, such as a digital wallet application, that can be used to communicate with the POS terminal and to provide the digital wallet payment instrument.

To conduct a transaction, the point of sale terminal can obtain the payment information from the user computing device. The point of sale terminal can submit the transaction details to a card network to receive payment from a card issuer.

Users may maintain digital wallet accounts and receive and store offers and other data from merchant systems, manufacturers, and others. To redeem offers in conventional systems, the user may be required to provide a physical offer to a merchant point of sale terminal, present offer data, or perform other required actions. The user computing device may transmit the offers and other customer data to the POS terminal to receive all of the benefits of the offers, such as discounts.

In conventional systems the user may be required to activate or “arm” an offer before tapping a user computing device to a POS terminal. Activating the offer instructs a secure element of the user computing device to store the offer and prepare the offer for communication to the POS terminal. In other conventional systems, activating the offer instructs the processor on the user computing device to store the offer and prepare the offer for communication to the POS terminal. To select an offer for activation, the user may manually actuate a button or other object to activate the offer. When the user provides the indication that the offer is to be activated, the user computing device communicates the offer to the secure element in preparation for communication to the POS terminal.

In conventional systems, the user lacks a confidence of exactly which offers are activated and which offers are not activated.

### SUMMARY

Techniques herein provide computer-implemented methods to transmit offers to point of sale (“POS) terminals. Transmitting offers comprises a digital wallet system employing a server configured to manage a digital wallet account for a user, and a user computing device employing a digital wallet application. A user approaching a POS terminal to conduct a transaction opens a digital wallet application on the user computing device and accesses an offer page of an offer on the digital wallet application. When the offer page is accessed, the offer parameters are loaded onto a secure element of the user computing device or other memory location of the user computing device and readied for communication to the POS terminal. When the user taps the user computing device to the POS terminal, the offer is communicated. If the user navigates away from the offer page, the offer parameters are deactivated and are no longer readied for communication.

In certain other example aspects described herein, systems and computer program products to transmit offers to point of sale terminals are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to provide offers to a point of sale terminal, in accordance with certain example embodiments.

FIG. 2 is a block flow diagram depicting a method to provide offers to a point of sale terminal, in accordance with certain example embodiments.

FIG. 3 is a block flow diagram depicting a method to access a particular offer, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

In an example embodiment, a user computing device approaches a point of sale (“POS”) terminal at a merchant system to conduct a transaction. A user opens a digital wallet application on the user computing device and accesses an offer page of an offer on the digital wallet application. When the offer page is accessed, the offer parameters are loaded onto a secure element or other memory location of the user computing device and readied for communication to the POS terminal. When the user taps the user computing device to the POS terminal the offer is communicated. If the user navigates away from the offer page, the offer parameters are removed from the secure element and are no longer readied for communication.

In an example embodiment, a digital wallet system or other system manages a digital wallet account for a user. As used herein, the digital wallet system represents any suitable digital wallet account manager, such as a credit card issuer, a payment processing system, a banking institution, a user computing device manufacturer, or any other suitable system. The user associates one or more payment accounts with the digital wallet account. The payment accounts may be credit card accounts, debit accounts, bank accounts, stored value accounts, or any other suitable payment accounts.

The digital wallet system associates a customer identification (“ID”) with the user account. In an example, the customer ID allows any system to identify the digital wallet account of the user on the digital wallet system. The customer ID may allow a requestor to identify loyalty data of the user, offers associated with the digital wallet account, or any other data associated with the user digital wallet account that the user allows to be shared.

As the user approaches a POS terminal at a merchant location, the user opens the digital wallet application. The user may initiate the digital wallet application by selecting a button or other object on a user interface of the user computing device. In a user interface of the digital wallet application, the user selects an option to access one or more offers stored by the digital wallet application. The offers may be stored on the digital wallet system and associated with the user account. In another example, the offers are stored on the user computing device.

The digital wallet application provides an interface to allow the user to scroll through the offers to select an offer that is relevant to a pending transaction. For example, an offer may be relevant to a pending transaction if the offer is related to the merchant system at which the user is shopping, if the offer is related to a product the user will likely purchase, or if the offer is related for any other suitable reason.

The user scrolls through offers on the digital wallet application and lands on an offer. To display the offer, the digital wallet application opens an offer page related to the offer. For example, the offer page is a screen or window of the digital wallet application that displays details related to the selected offer, such as the merchant system at which the offer is valid, a particular product for which the offer is valid, an expiration date, a discount or other benefit for using the offer, and/or any other suitable parameters related to the offer. The user may scroll from offer page to offer page to select an appropriate offer.

When an offer page is displayed on the digital wallet application, the offer parameters are loaded onto the secure element of the user computing device. For example, if a user scrolls to a particular offer page, or otherwise accesses a page associated with the offer parameters, the offer is armed and readied for use. That is, the offer parameters are transmitted from the digital wallet application to the secure element of the user computing device. In another example, the offer parameters are placed in another memory location on the user computing device that is designated to be transmitted at a subsequent communication with a POS terminal. The memory location may be on a software based secure transmission application. In another example, the offer parameters may be stored in a general purpose storage location on the user computing device that is otherwise designated for transmitted at a subsequent communication with a POS terminal. The offer parameters are prepared for communication from the secure element on the user computing device to a POS terminal or other recipient should the user provide a tap or other instruction.

If the user navigates away from the offer page, or otherwise closes the offer page, the offer parameters are removed from the secure element. For example, the offer parameters are deleted from the secure element, parameters associated with a new offer are written over the offer parameters of the original offer, or in any suitable manner the offer parameters are removed from the secure element.

The user computing device is directed by the user to initiate the transaction with the POS terminal. The user swipes or taps the user computing device hosting the digital wallet application and initiates a communication between the user computing device and the POS terminal. The tap may represent any action that is required to initiate a communication with the POS terminal. For example, the tap may require that the user touch the user computing device to a surface of a card reader or the POS terminal. In another example, the tap may require that the user hover the user computing device 110 near an antenna of a card reader. Any other type of tap, swipe, or other initiating action may be employed.

The POS terminal may employ a card reader or other hardware or software to communicate wirelessly with the user computing device via NFC or other suitable technology, such as Bluetooth, WiFi, or infrared.

Upon the establishment of a communication between the user computing device and the POS terminal, the secure element of the user computing device communicates the offer parameters to the POS terminal. In addition to the offer parameters, the secure element may further communicate a customer identification (“ID”) associated with the user digital wallet account, or any other suitable data.

After the offer parameters are communicated to the POS terminal, the user may scroll the digital wallet application to another offer page. When a subsequent offer page is opened on the user interface of the digital wallet application, the offer parameters of the subsequent offer are provided to the secure element and prepared for communication to the POS terminal. The user taps the user computing device a second time to communicate the subsequent offer parameters to the POS terminal as described herein with respect to the first offer parameters. Any number of offers may be communicated to the POS terminal in a similar fashion.

The POS terminal receives an input of one or more products to be purchased in the pending transaction. For example, a product scanner may be used to collect data from a barcode or other machine-readable tag associated with the product. In another example, a salesperson enters product data into the POS terminal. Any other suitable method of receiving the product data may be used.

The POS terminal or the reader associated with the POS terminal requests payment account information and other suitable data from the user computing device. The user computing device assembles the necessary data for responding to the reader. The data may include the customer ID, a payment account number of a payment instrument on the digital wallet application, the expiration date of the payment instrument, the name of the user, or other suitable data. If the user computing device employs a secure element, the data may be extracted by the secure element from a storage location associated with the digital wallet application, such as a data storage unit of the user computing device.

The reader provides the customer ID and associated data to the POS terminal. The POS terminal applies any relevant offers or discounts received from the user computing device that are due to the user for the pending transaction.

For example, if a received offer included a 20% discount offer for a particular product that is being purchased by the user, then the POS terminal applies the discount to the pending transaction before requesting an authorization for the transaction from the issuer of the payment account. Any other suitable action may be taken based on the data in the offer parameters.

After loyalty rewards, offers, and other suitable actions are taken by the POS terminal, the transaction is conducted with a payment processing system. In an example, the POS terminal provides a request for authorization of the transaction through a credit card network associated with the user account on the digital wallet system. The issuer of the selected payment instrument provides an authorization for the transaction. The POS terminal receives the authorization and approves the transaction and provides a receipt to the user or the user computing device. In an example, the digital wallet system is the payment processing system and/or the account issuer.

In certain examples, the user is not required to use the digital wallet application to conduct the transaction. For example, the user may tap the user computing device to transmit the offer parameters, but then elect to pay cash after the POS terminal applies the offer and loyalty data to the transaction.

By using and relying on the methods and systems described herein, the digital wallet system of a user dynamically provides offers to a POS terminal to apply to a pending transaction. By providing arming the offers when the user opens the offer page, the systems and methods described herein may be employed to prevent a user from inadvertently failing to activate or arm an offer. The system is improved for a user in that the user will have an improved confidence that an offer has been applied. Hence, the methods and systems described herein reduce the instances that users erroneously believed an offer had been activated.

### Example System Architectures

Turning now to the drawings, in which like numerals represent like (but not necessarily identical) elements throughout the figures, example embodiments are described in detail.

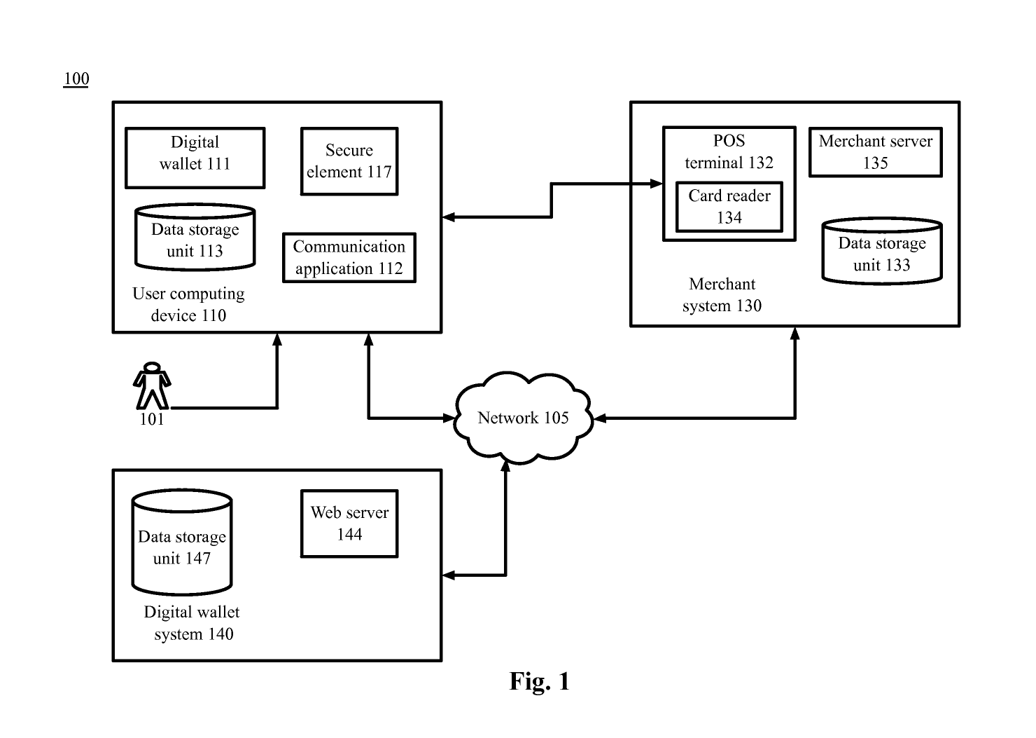

FIG. 1 is a block diagram depicting a system 100 to provide offers to a point of sale (“POS”) terminal 132, in accordance with certain example embodiments. In some embodiments, a user 101 associated with a device must install an application and/or make a feature selection to obtain the benefits of the techniques described herein.

As depicted in FIG. 1, the system 100 includes network computing devices 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device 110, 130, and 140 includes a computing device having a communication application capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 130, and 140 are operated by end-users or consumers, merchant system operators, and digital wallet system operators, respectively.

The user 101 can use the communication application 112 on a user computing device 110, which may be, for example, a web browser application or a stand-alone application, to view, download, upload, or otherwise access documents or web pages via the network 105. The communication application 112 can interact with web servers or other computing devices connected to the network 105, including the web server 144 of the digital wallet system 140.

In another example, the communication application 112 communicates with the point of sale (“POS”) terminal 132 or a card reader 134 via near field communication (“NFC”) or other wireless communication technology, such as Bluetooth, WiFi, infrared, or any other suitable technology.

The user computing device 110 may include a digital wallet application 111. The digital wallet application 111 may encompass any application, hardware, software, or process the user computing device 110 may employ to assist the user 101 in completing a purchase. The digital wallet application 111 can interact with the communication application 112 or can be embodied as a companion application of the communication application 112. As a companion application, the digital wallet application 111 executes within the communication application 112. That is, the digital wallet application 111 may be an application program embedded in the communication application 112. In certain embodiments a digital wallet of the user 101 may reside in a cloud computing environment, on a merchant server 135, or in any other environment.

The user computing device 110 also includes a data storage unit 113 accessible by the digital wallet application 111 and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory devices or removable flash memory. In certain embodiments, the data storage unit 113 may reside in a cloud based computing system.

An example user computing device 110 comprises a secure element 117 or other secure memory, which can exist within a removable smart chip or a secure digital (“SD”) card, which can be embedded within a fixed chip on the device 110, or be realized as a secure compartment of a security-enhanced operating system. In certain example embodiments, Subscriber Identity Module (“SIM”) cards may be capable of hosting a secure element 117, for example, an NFC SIM Card. The secure element 117 allows a software application resident on the device 110 and accessible by the user 101 to interact securely with certain functions within the secure element 117, while protecting information stored within the secure element 117. The secure element 117 comprises applications running thereon that perform certain functions described herein. In an example embodiment, the secure element 117 comprises components typical of a smart card, such as crypto processors and random generators. In an example embodiment, the secure element 117 comprises a Smart MX type NFC controller in a highly secure system on a chip controlled by a smart card operating system, such as a JavaCard Open Platform (“JCOP”) operating system. In another example, the secure element 117 is configured to include a non-EMV type contactless smart card, as an optional implementation. The secure element 117 communicates with the digital wallet application 111 in the user computing device 110. In an example embodiment, the secure element 117 is capable of storing encrypted user information and only allowing trusted applications to access the stored information.

The digital wallet system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service.

The digital wallet system 140 may be any system that manages, configures, enables, or otherwise services a digital wallet for a user 101. The digital wallet system 140 may provide a mechanism for a user 101 to conduct transactions with a merchant system 130. The digital wallet system 140 may provide software or other applications to a user computing device 110 to conduct digital wallet transactions on the user computing device 110.

The digital wallet system 140 may provide the user 101 with a customer identification (“ID”) that identifies the account of the user 101 on the digital wallet system 140. The digital wallet system 140 may utilize the customer ID to access loyalty information of the user 101, stored or associated offers, payment instruments, or other suitable data. The user 101 may utilize one or more payment instruments (not pictured). The payment instrument may be any type of payment card provided by a card issuer, banking institution, merchant system stored value program, or any other suitable system. The payment instrument may be used to fund a transaction conducted by the user 101 with the digital wallet account of the user 101. In certain examples, the digital wallet system 140 also provides the payment instrument.

An example merchant system 130 comprises a server 135, a data storage unit 133, a merchant POS terminal 132, and a card reader 134.

In an example embodiment, the server 135 communicates with the digital wallet system 140 or another payment processing system (not pictured) to conduct transactions. The merchant server 135 receives data from the POS terminal 132 and assists in conducting transactions with payment processing systems, card issuers, and other suitable systems.

In an example embodiment, the data storage unit 133 can include any local or remote data storage structure accessible to the merchant system 130 suitable for storing information. In an example embodiment, the data storage unit 133 stores encrypted information.

In an example embodiment, the merchant POS terminal 132, such as a cash register, is capable of processing a purchase transaction initiated by a user 101. In an example embodiment, the merchant system 130 operates a commercial store and the user 101 indicates a desire to make a purchase by presenting a form of payment at the merchant POS terminal 132. In an example embodiment, the merchant POS terminal 132 is capable of communicating with the user computing device 110 using an NFC, Bluetooth, and/or Wi-Fi communication method. In an example, the POS terminal 132 utilizes a card reader 134 to communicate with a user computing device 110 of the user 101. The card reader may receive data from a magnetic stripe, NFC, or any other suitable payment instrument technology.

It will be appreciated that the network connections shown are examples and other means of establishing a communications link between the computers and devices can be used. Moreover, those having ordinary skill in the art having the benefit of the present disclosure will appreciate that the merchant system 130, digital wallet system 140, and the user computing device 110 illustrated in FIG. 1 can have any of several other suitable computer system configurations. For example, a user computing device 110 embodied as a mobile phone or handheld computer may not include all the components described above.

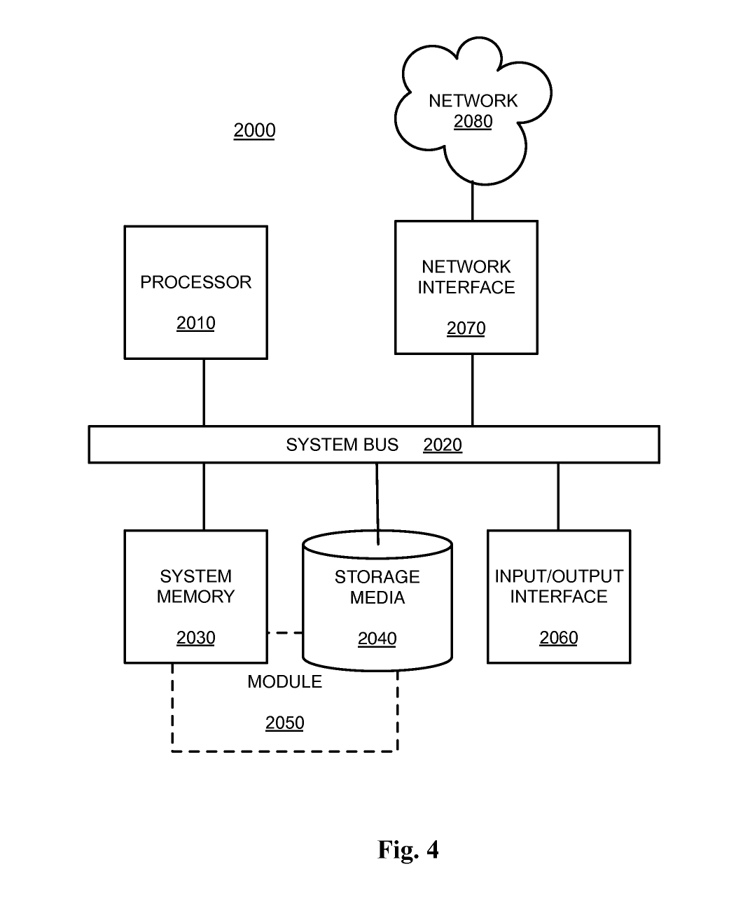

In example embodiments, the network computing devices and any other computing machines associated with the technology presented herein may be any type of computing machine such as, but not limited to, those discussed in more detail with respect to FIG. 4. Furthermore, any functions, applications, or modules associated with any of these computing machines, such as those described herein or any other others (for example, scripts, web content, software, firmware, or hardware) associated with the technology presented herein may by any of the modules discussed in more detail with respect to FIG. 4. The computing machines discussed herein may communicate with one another, as well as with other computing machines or communication systems over one or more networks, such as network 105. The network 105 may include any type of data or communications network, including any of the network technology discussed with respect to FIG. 4.

### Example Processes

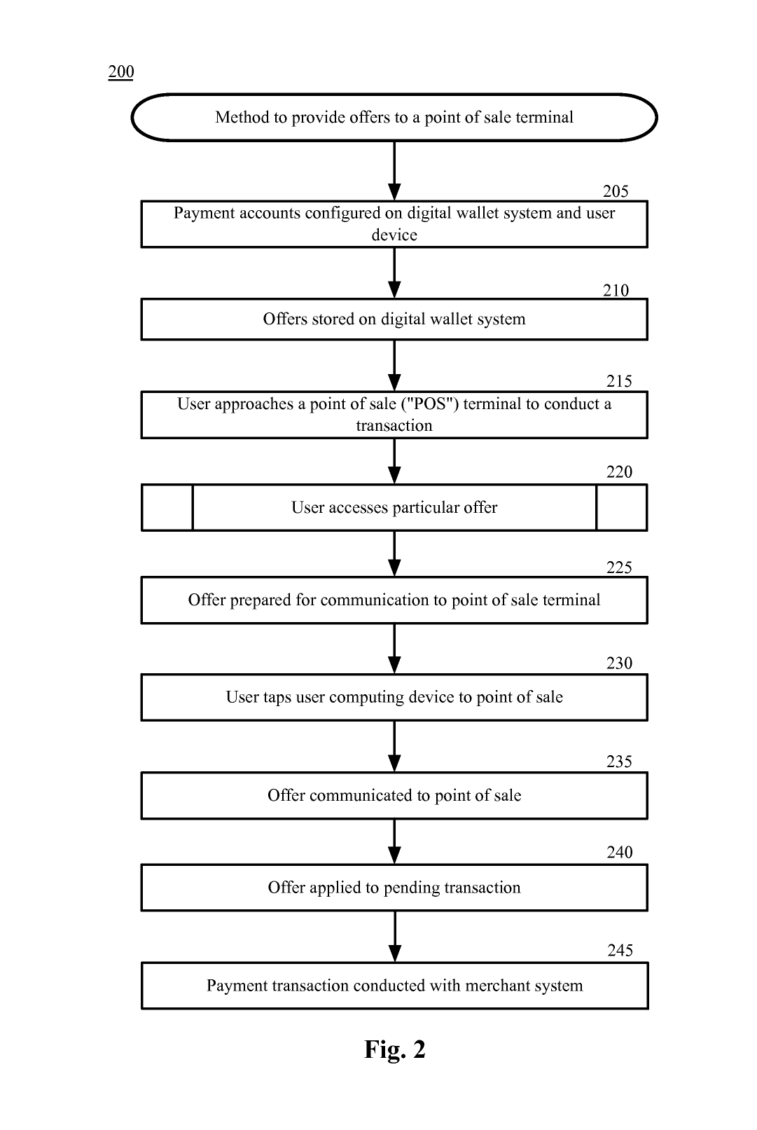

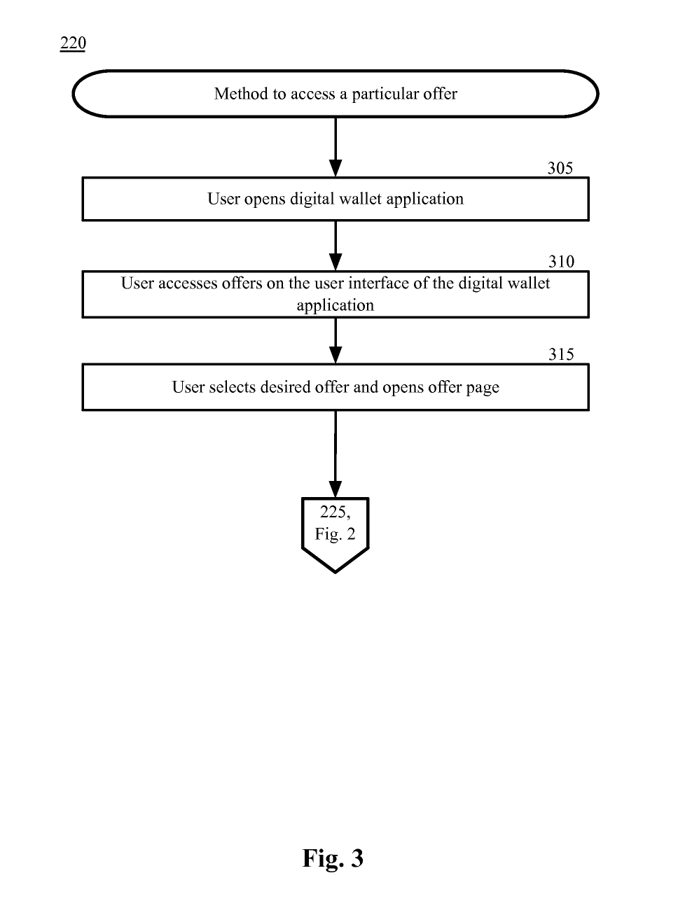

The example methods illustrated in FIGS. 2-3 are described hereinafter with respect to the components of the example operating environment 100. The example methods of FIGS. 2-3 may also be performed with other systems and in other environments.

FIG. 2 is a block flow diagram depicting a method 200 to provide offers to a POS terminal 132, in accordance with certain example embodiments.

With reference to FIGS. 1 and 2, in block 205, payment accounts are configured on a digital wallet system 140 and a user computing device 110. The user 101 associates one or more payment accounts with a digital wallet account of the user 101 on the digital wallet system 140. The digital wallet system 140 provides software to the user computing device 110 to install a digital wallet application 111 on the user computing device 110. The user 101 or the digital wallet system 140 may configure the digital wallet application 111 with the digital wallet data from the digital wallet system 140. In an example, the digital wallet account on the digital wallet system 140 and the digital wallet application 111 may be configured with one or more payment accounts of the user 101. The payment accounts may be credit card accounts, debit accounts, bank accounts, stored value accounts, or any other suitable payment accounts. The digital wallet account may be configured with loyalty information of the user 101 for one or more merchant systems 130. The digital wallet account may be configured with offers associated with the user 101 from merchant systems 130, manufacturers, or other systems.

In block 210, offers are stored on the digital wallet system 140. The digital wallet system 140 stores the received offers in a data storage unit 147. The offers may be stored in categories related to the offers, such as by the name of the merchant system 130 that provided the offer, the type of discount or reward offered, the merchant category code of the merchant system 130, the type of product associated with the offer, the expiration date of the offer, or any other suitable category. The database may be stored on the web server 144 of the offer distribution system 140. The offers may additionally or alternatively be stored on the user computing device 110. For example, the offers may be stored on the data storage unit 113 of the user computing device 110 and accessed via the user interface of the user computing device 110.

In another example, an offer page is associated with each stored offer. The offer page may be accessed via an internet connection with the digital wallet system 140, via the user interface of the digital wallet application 110, or via any suitable technology. The offer page may be a screen or window of the digital wallet application that displays details related to the selected offer, such as the merchant system at which the offer is valid, a particular product for which the offer is valid, an expiration date, a discount or other benefit for using the offer, and/or any other suitable parameters related to the offer. The user may scroll from offer page to offer page to select an appropriate offer. The user may access the offer page by actuating a button or other object on the user computing device 110, by scrolling through a menu on the user computing device 110, or in any other suitable manner navigating to the offer page.

Offers may be provided to the digital wallet system 140 by a merchant system 130, an offer distribution system (not pictured), a manufacturer, or any suitable system or party. In an example, the offers may be viewed by the user 101 in a list of offers and one or more of the viewed offers may be saved by the user 101. In another example, the user 101 views an offer at a third party location, such as a web site of a particular product. The user 101 may provide an input to the user computing device 110 to save the offer to the digital wallet account of the user 101. Any other suitable method of obtaining offers and storing offers in a digital wallet account may be employed.

A provider of the offer compensates a distributor of the offer for displaying the offers. In an example, the digital wallet system 140 may act as an offer distributor. In another example, the digital wallet system 140 does not distribute offers, but merely receives and stores offers for the use of a user 101. The compensation may be based on factors such as a number of offers displayed on user computing devices 110, a number of instances that a user 101 clicks on or otherwise selects a provided offer, a number of actions taken by a user 101 that are related to the offer, or any other suitable factor. The offers created or submitted by merchant systems may provide information with the offer that identifies the conditions required to redeem the offer, such as a specific product that must be purchased. The offers may provide a merchant name, a product name, an expiration date, and other suitable information for each particular offer.

In block 215, a user 101 approaches a point of sale (“POS”) terminal 132 to conduct a transaction. In an example, the POS terminal 132 is a cash register or other terminal at a physical location of a merchant system 130. For example, the user 101 visits the location and selects a product for purchase. The user 101 locates an open POS terminal 132 or waits in a line for a POS terminal 132 to become available.

In block 220, the user 101 accesses a particular offer. The details of block 220 are described in greater detail with respect to method 220 of FIG. 3.

FIG. 3 is a block flow diagram depicting a method 220 to accesses a particular offer, in accordance with certain example embodiments.

In block 305, the user 101 opens the digital wallet application 111. In an example, the user 101 actuates a real or virtual button or other object to initiate the digital wallet application 111. In another example, the POS terminal 132 communicates a beacon or other signal to indicate to the user computing device 110 that a transaction may be pending and that the digital wallet application 111 may be required. The beacon may be communicated via near field communication (“NFC”) or other wireless communication technology, such as Bluetooth, WiFi, infrared, or any other suitable technology. In another example, the digital wallet application 111 is already initiated, but the user 101 actuates a button or performs any suitable action to cause the digital wallet application 111 to be positioned in the forefront of the user interface of the user computing device 110.

In block 310, the user 101 accesses offers on the user interface of the user computing device 110. The digital wallet application 111 provides an interface to allow the user 101 to scroll through stored offers to select an offer that is relevant to a pending transaction. For example, an offer may be relevant to a pending transaction if the offer is related to the merchant system 130 at which the user 101 is shopping, if the offer is related to a product the user 101 will likely purchase, or if the offer is related for any other suitable reason. The offers may be accessed directly from the list of stored offers. The offers may be sorted by category, expiration date, merchant identity, or any other suitable characteristic. The offers may be searched based on keyword, merchant identity, product identification, or any other suitable characteristic. The offers may be presented to the user 101 in a ranked list, the ranking being determined based on the relevance of the offer to the location of the user 101.

In block 315, the user 101 selects a desired offer and opens the offer page. For example, the user 101 scrolls through offers on the digital wallet application 111 and selects an offer that the user 101 intends to redeem in the pending transaction. When the offer is selected, such as when the user 101 actuates a virtual button associated with the selected offer, the digital wallet application 111 opens an offer page related to the offer. For example, the offer page is a screen or window of the digital wallet application 111 that displays details related to the selected offer, such as the merchant system 130 at which the offer is valid, a particular product for which the offer is valid, an expiration date, a discount or other benefit for using the offer, and/or any other suitable parameters related to the offer. In an example, the user 101 may scroll or otherwise navigate from offer page to offer page to select an appropriate offer. The offer page may open in the user interface of the digital wallet application 111, in a web page, or in any suitable display.

From block 315, the method 220 returns to block 225 of FIG. 2.

Returning to FIG. 2, in block 225, the offer is prepared for communication to POS terminal 132 by loading the offer onto a secure element 117 or otherwise preparing the offer for communication to the POS terminal 132. In an example, the offer is loaded onto the secure element 117 of the user computing device 110 for communication to the POS terminal 132. In another example, the offer parameters are loaded to an application or other software system on the user computing device 110 that readies the offer to be communicated to the POS terminal 132 when the user computing device 110 next communicates with a POS terminal 132. When an offer page is displayed on the digital wallet application 111 or other suitable display application, the offer parameters associated with the displayed offer are loaded onto the secure element of the user computing device 110 or other storage location. For example, if a user 101 scrolls to an offer page, or otherwise accesses a page associated with the offer parameters, the offer is armed and readied for use. That is, the offer parameters are transmitted from the digital wallet application 111 to the secure element 117 of the user computing device 110. The offer parameters are prepared for communication from the secure element 117 to a POS terminal 132 or other recipient should the user 101 provide a tap or other instruction.

In an example, the offers parameters are communicated to the secure element 117 from the digital wallet application 111 operating on the user computing device 110 via the processor of the user computing device 110. That is, the secure element 117 accesses the offer data on the data storage unit 113 and downloads the offer parameters. In another example, the secure element obtains the offer parameters via an internet connection to a trusted service manager.

If the user 101 navigates away from the offer page, or otherwise closes the offer page, the offer parameters are removed from the secure element 117 or other storage location. For example, the offer parameters are deleted from the secure element 117 or other storage location, parameters associated with a new offer are written over the offer parameters of the original offer, or in any suitable manner the offer parameters are removed. By removing the offer parameters, the offer is no longer activated or armed.

In block 230, the user 101 taps the user computing device 110 to the POS terminal 132. The user 101 taps the user computing device 110 to the POS terminal 132 to initiate a communication. In a certain example, the user 101 swipes or taps the user computing device 110 on a POS terminal reader 134 that is logically connected to the POS terminal 132. In an example, the user 101 approaches the POS terminal 132 associated with the received beacon with one or more items for purchase. The user 101 swipes or taps the user computing device 110 and initiates a communication between the digital wallet application 111 on the user computing device 110 and the POS terminal 132. The tap may represent any action that is required to initiate a communication with the POS terminal 132. For example, the tap may require that the user 101 touch the user computing device 110 to a surface of a card reader 134 or the POS terminal 132. In another example, the tap may require that the user 101 hover the user computing device 110 near an antenna of a reader 134. Any other type of tap, swipe, or other initiating actions, may be employed. The POS terminal 132 may employ a card reader 134 or other hardware or software to communicate wirelessly with the payment instrument 115 via NFC or other suitable technology or the POS terminal 132 may communicate with the user computing device 110 directly.

In block 235, the offer is communicated to the POS terminal 132. Upon the establishment of a communication between the user computing device and the POS terminal 132, the secure element 117 of the user computing device 110 communicates the offer parameters to the POS terminal 132. In addition to the offer parameters, the secure element 117 may further communicate a customer identification (“ID”) associated with the user digital wallet account, or any other suitable data. The communication from the secure element 117 may be via near field communication (“NFC”), BLUETOOTH, barcode, Wi-Fi, infrared, or any other suitable communication technology. The offer parameters are communicated to the POS terminal 132 with any other required data, such as the customer ID of the user 101.

In block 240, the offer parameters are applied to the pending transaction. The POS terminal 132 receives an input of one or more products to be purchased in the pending transaction. For example, a product scanner may be used to collect data from a barcode or other machine-readable tag associated with a product. In another example, a salesperson enters product and transaction data into the POS terminal 132. Any other suitable method of receiving the product data may be used.

The POS terminal 132 totals the transaction funds required and then applies the offer to the transaction. For example, if the offer were for 50% off the price of a particular product associated with the transaction, then the POS terminal 132 would deduct 50% from the price of the particular product and recalculate the total amount of funds required for the transaction.

The POS terminal 132 uses the offer parameters to confirm that all conditions are met to redeem the offer. For example, the POS terminal 132 may verify that the offer has not expired, that the user 101 has not previously redeemed the offer, that a required transaction minimum value has been exceeded, or that any other required condition has been met.

In block 245, the POS terminal 132 conducts the transaction. The POS terminal 132 conducts the transaction with the customer data received from the user computing device 110, the secure element 117, and the digital wallet system 140. In an example, the card reader 134 associated with a POS terminal 132 requests payment account information and other suitable data from the user computing device 110. The user computing device 110 assembles the necessary data for responding to the reader 134. The data may include the customer ID, a payment account number of the digital wallet account 111, and other suitable data. The user computing device 110 transmits the customer ID and other data to the reader 134 on the POS terminal 132. Some or all of the data is transmitted via the secure element 117. Other data may be transmitted by functions of the user computing device 110 other than the secure element 117. In certain example, the user computing device 110 only transmits the customer ID. In this example, any additional required information, such as the payment account number, user name, account expiration dates, or any other required data is obtained from the digital wallet system 140 based on the provided customer ID.

The POS terminal 132 transmits an authorization request to a suitable payment processing system. The POS terminal 132 identifies the transaction total and provides an authorization request to a credit card network, a payment processing system, a banking institution, or any suitable system that will provide an authorization for the transaction and process the transaction. The POS terminal 132 may utilize the merchant system server 125 to obtain the authorization. In an example, the digital wallet system 140 may function as the payment processing system and receive the request for an authorization of the transaction. The authorization is provided to the POS terminal 132 and the transaction is completed.

The digital wallet application 111 and the digital wallet system 140 record the transaction data. The POS terminal 132 displays the authorization to the user 101 and/or a salesperson of the merchant system 130. The user 101 receives the purchased product or service and a paper and/or digital receipt for the transaction.

The digital wallet system 140 stores data associated with the conducted transaction to allow loyalty points to be accrued, offer data to be updated, or any other suitable action to be taken.

### Example Systems

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to activate offers, comprising:
initiating, using one or more computing devices, a digital wallet application;
displaying, using the one or more computing devices and on a user interface of the digital wallet application, a listing of one or more offers;
receiving, using the one or more computing devices, an input from a user requesting a display of an offer page associated with a particular offer;
displaying, using the one or more computing devices, the offer page;
at a time that the offer page is displayed, communicating, using the one or more computing devices and to a secure element associated with the one or more computing devices, offer parameters associated with the particular offer and instructions to communicate the offer parameters to a point of sale terminal at a time that the user initiates a communication with the point of sale terminal;
receiving, using the one or more computing devices, an initiation of a communication with the point of sale terminal; and
communicating, using the one or more computing devices, the offer parameters to the point of sale terminal.

2. The computer-implemented method of claim 1, further comprising:
receiving, using the one or more computing devices, an input from the user navigating the user interface of the digital wallet application away from the offer page; and
communicating, using the one or more computing devices and to the secure element associated with the one or more computing devices, instructions to remove the offer parameters from the secure element.

3. The computer-implemented method of claim 1, further comprising:
receiving, using the one or more computing devices, an input from the user requesting a display of a second offer page associated with a second offer;
at the time that the second offer page is displayed, communicating, using the one or more computing devices and to the secure element associated with the one or more computing devices, a second set of offer parameters associated with the second offer and instructions to communicate the second set of offer parameters to the point of sale terminal at a time that the user initiates a communication with the point of sale terminal;
receiving, using the one or more computing devices, a second initiation of a communication with the point of sale terminal; and
communicating, using the one or more computing devices, the second set of offer parameters to the point of sale terminal.

4. The computer-implemented method of claim 1, further comprising:
receiving, using the one or more computing devices, a request for payment information from the point of sale terminal; and
providing, using the one or more computing devices, payment information to the point of sale terminal, the payment information being sufficient to conduct a transaction with a merchant system associated with the point of sale terminal.

5. The computer-implemented method of claim 4, further comprising:
applying, using the one or more computing devices, the offer parameters to the transaction, wherein applying the set of user data to the pending transaction comprises adjusting the pending transaction data based on the offer parameters.

6. The computer-implemented method of claim 1, wherein the offer page is stored on the digital wallet application.

7. The computer-implemented method of claim 1, wherein the offer page is accessed from a server of a digital wallet system over the network.

8. The computer-implemented method of claim 1, wherein the offer parameters are communicated to the point of sale terminal via near field communication.

9. The computer-implemented method of claim 1, wherein the communication with the point of sale is initiated with a tap of the one or more computing devices to the point of sale terminal.

10. The computer-implemented method of claim 1, further comprising communicating, using the one or more computing devices, an identification of the user account to the point of sale terminal concurrently with the offer parameters.

11. A computer program product, comprising:
a non-transitory computer-readable storage device having computer-executable program instructions embodied thereon that when executed by a computer cause the computer to activate offers, the computer-executable program instructions comprising:
computer-executable program instructions to display, on a user interface of the digital wallet application, a listing of one or more offers;
computer-executable program instructions to receive an input from a user requesting a display of an offer page associated with a particular offer;
computer-executable program instructions to communicate, at a time that the offer page is displayed and to a storage location associated with the one or more computing devices, offer parameters associated with the particular offer and instructions to communicate the offer parameters to a point of sale terminal at a time that the user initiates a communication with the point of sale terminal;
computer-executable program instructions to receive an initiation of a communication with the point of sale terminal; and
computer-executable program instructions to communicate the offer parameters to the point of sale terminal.

12. The computer program product of claim 11, further comprising:
computer-executable program instructions to receive an input from the user navigating the user interface of the digital wallet application away from the offer page; and
computer-executable program instructions to communicate, to the secure element associated with the one or more computing devices, instructions to remove the offer parameters from the secure element.

13. The computer program product of claim 11, further comprising:
computer-executable program instructions to receive a request for payment information from the point of sale terminal; and
computer-executable program instructions to provide payment information to the point of sale terminal, the payment information being sufficient to conduct a transaction with a merchant system associated with the point of sale terminal.

14. The computer program product of claim 11, wherein the offer page is stored on the digital wallet application.

15. A system to select payment accounts to activate offers, comprising:
a storage resource; and
a processor communicatively coupled to the storage resource, wherein the processor executes application code instructions that are stored in the storage resource to cause the processor to:
computer-executable program instructions to receive an input from a user requesting a display of an offer page associated with a particular offer from a listing of one or more offers;
communicate, at a time that the offer page is displayed and to a communication application associated with the one or more computing devices, offer parameters associated with the particular offer and instructions to communicate the offer parameters to a point of sale terminal at a time that the user initiates a communication with the point of sale terminal;
receive an initiation of a communication with the point of sale terminal; and
communicate the offer parameters to the point of sale terminal.

16. The system of claim 15, further comprising application code instructions to:
receive an input from the user requesting a display of a second offer page associated with a second offer;
at the time that the second offer page is displayed, communicate to the secure element associated with the one or more computing devices, a second set of offer parameters associated with the second offer and instructions to communicate the second set of offer parameters to the point of sale terminal at a time that the user initiates a communication with the point of sale terminal;
receive a second initiation of a communication with the point of sale terminal; and
communicate the second set of offer parameters to the point of sale terminal.

17. The system of claim 15, further comprising application code instructions to:
receive an input from the user navigating the user interface of the digital wallet application away from the offer page; and
communicate, to the communication application associated with the one or more computing devices, instructions to remove the offer parameters from the secure element.

18. The system of claim 15, wherein the offer page is accessed from a server of a digital wallet system over the network.

19. The system of claim 15, wherein the offer parameters are communicated to the point of sale terminal via near field communication.

20. The system of claim 15, wherein the communication with the point of sale is initiated with a tap of the storage resource to the point of sale terminal.
